(19) United States
(12) Patent Application Publication
(10) Pub. No.: US 2018/0064132 A1
(43) Pub. Date: Mar. 8, 2018

(54) CHILLED OR FROZEN PRODUCT PREPARATION MACHINE

(71) Applicant: NESTEC S.A., Vevey (CH)

(72) Inventor: Andre Noth, Pully (CH)

(21) Appl. No.: 15/563,734

(22) PCT Filed: Apr. 4, 2016
(86) PCT No.: PCT/EP2016/057368

§ 371 Date: Oct. 2, 2017

(30) Foreign Application Priority Data
Apr. 7, 2015 (EP) 15162525.8

(51) Int. Cl. A23G 9/12; B01F 15/06; B01F 7/16; B01F 7/30; B01F 7/00

(52) U.S. Cl. CPC A23G 9/12; B01F 15/065; B01F 2015/00642; B01F 7/30; B01F 7/0095; B01F 7/1605

(57) ABSTRACT

The invention relates to a stirring mechanism (90) for a machine for preparing chilled or frozen products comprising one motor, the stirring mechanism (90) comprising one or a plurality of transmission paths between an input shaft (94) rotatable at a speed ωᵢₙ by the motor and an output shaft (98) rotatable at a speed ωₒᵤₜ, the transmission paths providing different values of the ratio ωᵢₙ/ωₒᵤₜ and being selectable as a function of the direction of rotation of the input shaft (94). The invention further relates to a machine (100) for preparing chilled or frozen products comprising a stirring mechanism (90) as described, the stirring mechanism (90) entraining in rotation stirring means (9) to prepare the product. Even further, the invention relates to a system comprising such a machine (100) and a container (10) comprising the ingredient or ingredients for preparing the product by the rotation of the stirring means (9).

### FIELD OF THE INVENTION

The present invention is directed to a machine for preparing a plurality of chilled or frozen products such as ice-cream, milkshakes, sorbets, frozen or whipped yoghurt or the like. In particular, the invention is directed to the stirring device in such a preparation machine.

### BACKGROUND OF THE INVENTION

Currently, a known solution for the fresh preparation of texturized chilled or frozen products such as ice-cream, milkshakes, sorbets, frozen yoghurt, whipped yoghurt, smoothies, cold beverages or the like is to use machines, such as blender, yoghourt maker or ice-cream maker to produce fresh products of the type previously referred to.

Solutions have been provided to allow the preparation of texturized chilled or frozen products in a reduced amount of time, departing from liquid initial ingredients at ambient temperature. An example is provided in EP 12190562.4 belonging to the same applicant, where a system allowing the preparation of fresh chilled or frozen products in a reduced time of around 5 minutes is described, this system allowing the preparation of desserts in containers that are prefilled with product and which are cooled through a thermally conductive part in these containers. The system in EP 12190562.4 comprises a device and a container; the container comprises the liquid ingredients at ambient temperature to prepare the final product. The preparation process encompasses cooling and mixing, as well as air incorporation, with the product staying in the original container. Another example is that in EP 14167344.2 where the ingredients for the preparation of the products are provided by a disposable dispensing container directly into the container where the preparation process will take place.

In any of the cases described above, for a good aeration and to ensure a fast and homogeneous heat transfer to the product from the walls of the thermally conductive parts in the container, a stirring device is of primary importance.

Known stirring devices comprise a stirrer typically provided with two rotations: a first rotation of the stirrer around its own axis, typically known as spin rotation; and a second rotation of the stirrer around the container axis, typically known as gyration. The combination of these two rotations, known as epicyclical movement, of the stirrer is able to provide good aerated desserts which are cooled in a short time.

This epicyclical movement is used in known food preparation machines, such as Hobart® or Kitchenaid®, comprising one motor that creates the two rotations of the stirrer thanks to an epicyclical gearing. In these machines, different rotations speed can be selected, in most of the cases through a manual action, but the ratio between the two speeds remains always fixed. This single ratio can be pre-defined for the stirring of certain products but might not be adequate for others.

Machines envisaging an automatic switch or change among different and independent speeds of the stirrer, leading to more than one ratio, would necessarily be designed with two motors that would drive independently the two speeds (rotation and gyration) of the stirrer, resulting in a more complex, larger, heavier and more costly machine.

The present invention comes to solve the above-described problems, as it will be further explained. The invention also aims at other objects and particularly the solution of other problems as will appear in the rest of the present description.

### OBJECT AND SUMMARY OF THE INVENTION

According to a first aspect, the invention refers to a stirring mechanism for a machine for preparing chilled or frozen products comprising one motor, the stirring mechanism comprising one or a plurality of transmission paths between an input shaft rotatable at a speed ωᵢₙ by the motor and an output shaft rotatable at a speed ωₒᵤₜ, the transmission paths providing different values of the ratio ωᵢₙ/ωₒᵤₜ and being selectable as a function of the direction of rotation of the input shaft.

Preferably, the transmission paths comprise transmission gears arranged at different heights. The output shaft typically comprises one or a plurality of gear stages engaging with transmission gears as a function of the direction of rotation of the input shaft such that different ratios ωᵢₙ/ωₒᵤₜ can be provided depending on the product.

According to a preferred embodiment, the transmission gears are arranged in the input shaft.

Still according to another preferred embodiment, the output shaft comprises two gear stages engaging with transmission gears depending on the direction of rotation of the input shaft, so two different ratios ωᵢₙ/ωₒᵤₜ are provided as a function of the product targeted.

According to the invention, the ratio ωᵢₙ/ωₒᵤₜ is negative when the number of gears in the transmission gear engaging with the output shaft is an even number. The ratio ωᵢₙ/ωₒᵤₜ is positive when the number of gears in the transmission gear engaging with the output shaft is an odd number.

Preferably, the number of gears in the transmission gears is selected so as to provide different combinations of positive and/or negative ratios ωᵢₙ/ωₒᵤₜ as a function of the direction of rotation of the input shaft.

According to a preferred embodiment of the invention, at least one of the transmission gears comprises a gear box.

Further according to another preferred embodiment of the invention, the stirring mechanism further comprises an inner gear guiding the rotation of the transmission gears around the stirring mechanism axis. Preferably, the ratio ωᵢₙ/ωₒᵤₜ depends on the number of teeth in the internal gear and/or in the transmission gears.

Typically, the inner gear comprises different internal diameters engaging with transmission gears depending on the direction of rotation of the input shaft so that different ratios ωᵢₙ/ωₒᵤₜ are provided.

According to another embodiment, the stirring mechanism is further configured such that it comprises a disengagement angle α₁ where the input shaft rotates while the output shaft remains static.

Preferably, the stirring mechanism comprises first and second contacting elements collaborating with the input shaft in order to define the disengagement angle α₁.

According to a second aspect, the invention relates to a machine for preparing chilled or frozen products comprising a stirring mechanism as previously described, the stirring mechanism entraining in rotation stirring means to prepare the product.

Yet according to a third aspect, the invention relates to a system comprising a machine as previously described and a container comprising the ingredient or ingredients for preparing the product by the rotation of the stirring means.

### BRIEF DESCRIPTION OF THE DRAWINGS

Further features, advantages and objects of the present invention will become apparent for a skilled person when reading the following detailed description of embodiments of the present invention, when taken in conjunction with the figures of the enclosed drawings.

FIG. 1 shows the different main elements of a system for preparing chilled or frozen products, comprising a chilled or frozen product preparation machine according to the present invention.

FIG. 2 shows the epicyclical movement of a stirring element with a combination of two rotational speeds, in the known prior art.

FIG. 3a shows a typical embodiment of a stirring mechanism provided with epicyclical movement according to the known prior art.

FIG. 3b shows the output rotational speed obtained as a function of the input rotational speed provided, in a stirring mechanism provided with epicyclical movement according to the known prior art as shown in FIG. 3a.

FIGS. 4a-c show different views of a stirring mechanism in a chilled or frozen product preparation machine according to the present invention.

FIGS. 5a-b show different views showing the movement of the stirring mechanism in a chilled or frozen product preparation machine according to the present invention as shown in FIGS. 4a-c, when the input rotational speed is clockwise.

FIGS. 6a-b show different views showing the movement of the stirring mechanism in a chilled or frozen product preparation machine according to the present invention as shown in FIGS. 4a-c, when the input rotational speed is counter clockwise.

FIG. 7 shows the speed ratios obtained by the stirring mechanism in a chilled or frozen product preparation machine according to the present invention as shown in FIGS. 4a-c when the input rotation is clockwise (FIGS. 5a-b) or counter clockwise (FIGS. 6a-b).

FIGS. 8a-b show different speed ratios that can be obtained by the stirring mechanism in a chilled or frozen product preparation machine according to the present invention as shown in FIGS. 4a-c by modifying the number of gears in the transmission gears, the output rotation being non dependent on the input rotation direction.

FIGS. 8c-d show different speed ratios that can be obtained by the stirring mechanism in a chilled or frozen product preparation machine according to the present invention as shown in FIGS. 4a-c by modifying the number of gears in the transmission gears, the output rotation being dependent on the input rotation direction.

FIG. 9 shows a possible embodiment of the stirring mechanism in a chilled or frozen product preparation machine according to the present invention, where a gearbox is provided in one of the transmission gears.

FIG. 10 shows another possible embodiment of the stirring mechanism in a chilled or frozen product preparation machine according to the present invention, where different diameters are provided in the fixed internal gear.

FIG. 11 shows in cross section view the stirring mechanism in a chilled or frozen product preparation machine according to the present invention as represented in FIGS. 4a-c.

FIG. 12 shows another possible embodiment of the stirring mechanism in a chilled or frozen product preparation machine according to the present invention, where a gearbox is provided in another one of the transmission gears.

### DETAILED DESCRIPTION OF EXEMPLARY EMBODIMENTS

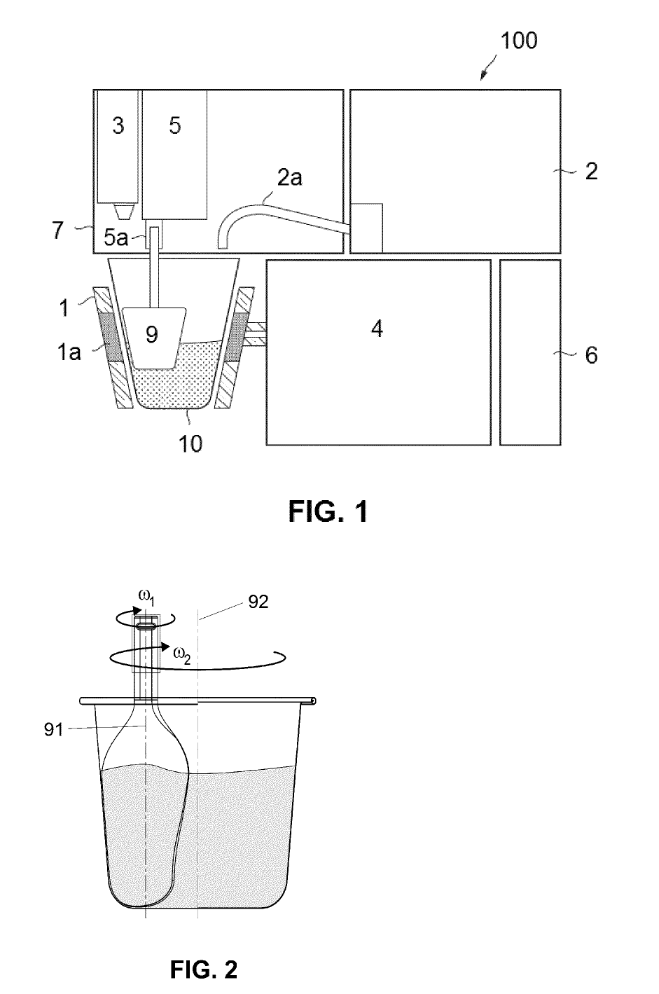

FIG. 1 relates to a preferred embodiment of a system comprising a chilled or frozen product preparation machine 100 according to the present invention and a preparation container 10. The preparation container 10 preferably comprises the ingredient or ingredients that will be processed by the preparation machine 100 in order to obtain the final chilled or frozen product targeted. Another possibility is that these ingredients have been dispensed into the preparation container 10 from a dispensing container, preferably disposable. Typically, depending on the product to be prepared in the respective container 10, its size and volume will be adapted to contain a predefined amount of ingredients necessary for preparing the specific targeted product. In what follows in the present description, both possibilities should be comprised within the scope of the present invention: the container 10 already comprising the ingredients, or a dispensing container delivering the ingredients into the container 10.

As schematically shown in FIG. 1, the preparation machine 100 preferably comprises receiving means 1 for receiving the preparation container 10 therein, preferably shaped in V-form when seen in sectional side view. According to such an embodiment, containers 10 of different sizes respectively volumes may be supported by the receiving means 1.

The preparation machine 100 further comprises a cooling unit 4 connected to a cooling element 1a that is preferably connected to or integrally formed with the receiving means 1 of the machine 100. The cooling element 1a is preferably an evaporator connected to the cooling unit 4 of the machine, preferably arranged at an inner surface of the receiving means 1. The cooling element 1a thus serves as a heat exchanger that withdraws the heat energy from the container 10 and its enclosed confectionary product. The cooling element 1a is further of a material which provides excellent heat transfer properties, such as e.g. metal. Accordingly, the heat transfer between the container 10 and the cooling element 1a is significantly enhanced.

The cooling unit 4 of the machine 100 is adapted to cool the cooling element 1a. The cooling unit 4 can comprise any refrigeration and/or circulatory heat transfer system to cool the cooling element 1a and consequently the container 10 as rapidly as possible.

The machine 100 may comprise a liquid tank 2 for holding liquid such as e.g. water and a dedicated pump. The liquid tank 2 is preferably connected to liquid dispensing means 2a for providing liquid to the container 10 when being placed within the receiving means 1 of the machine 100.

Furthermore, the machine 100 may comprise a topping tank 3 and an associated valve or pump (not shown) for providing toppings in solid or liquid form to the product prepared in the container 10. The toppings may be liquid coulis, liquid chocolat, caramel or solid products like crisps, flakes, chocolate bits. Additionally, the toppings may be liquefied by means of an additionally provided heating source such as e.g. melted chocolate.

The machine 100 further comprises a stirring device 5 adapted to connect to stirring means 9. For this reason, the stirring device 5 is preferably equipped with connection means 5a designed for selectively connecting to the stirring means 9. The stirring means 9 may either be part of the machine 100 or be provided as integral part of the container 10.

The machine 100 further comprises a control unit 6 for controlling the operations of the components of the machine. The control unit 6 may further comprise sensors and container recognition means (not shown) which are arranged to interact with identification means provided on the container 10.

The topping tank 3 and the stirring device 5 are preferably mounted on a mobile structure 7 of the machine in order to allow the insertion and removal of the container 10 into and from the container receiving means 1. The mobile structure 7 is thus adapted to be moved relatively to the rest of a housing of the machine 100 from a closed position (shown in FIG. 1) to an open position (not shown). Thereby, the movement of the mobile structure 7 with respect to the rest of the machine 100 may be rotation or translation.

The present invention specifically refers to a stirring device 5 in the preparation machine 100: in order to aerate and to ensure a fast heat transfer to the product in the container 10, stirring is a key factor and is done through an epicyclical movement of the stirring means 9, meaning that two rotations are used, as schematically represented in FIG. 2:
a first rotation ω₁ of the stirring means 9 around its own axis (stirring means axis 91), called rotation;
a second rotation ω₂ of the stirring means 9 around the container axis 92, called gyration.

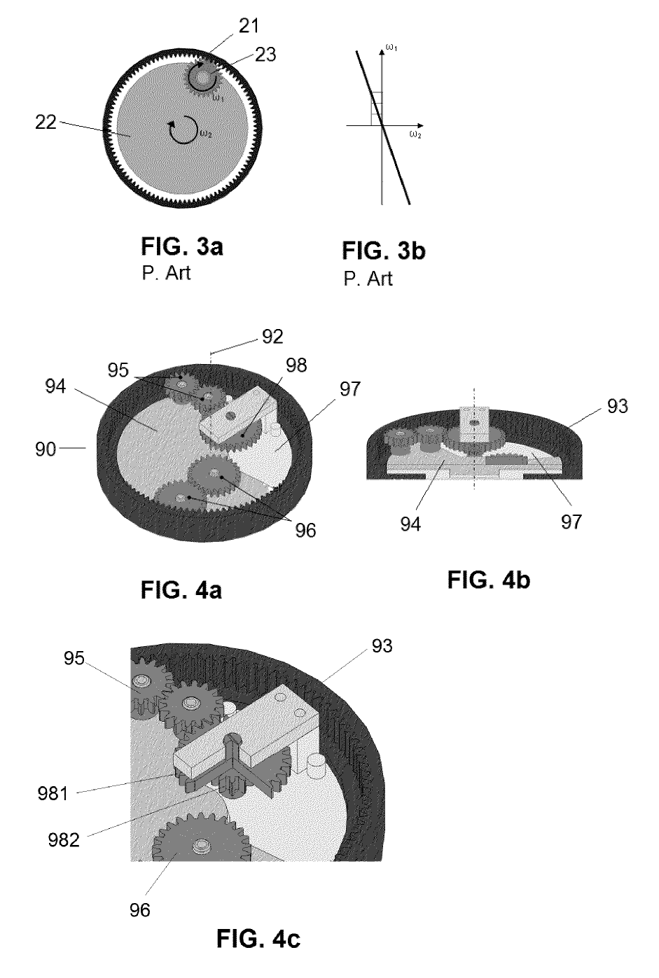

FIGS. 2, 3a and 3b show the principle of a known epicyclic movement of the stirring means 9 in the prior art provided by a standard epicyclic gear mechanism: as one motor is used to entrain in rotation the stirring means 9, the two speeds ω₁ and ω₂ provided always have one single constant ratio (ω₁/ω₂) regardless of the speed values (see FIG. 3b). For example, as shown in FIG. 3a, a fixed external gear 21 has for example 100 teeth in its internal surface: the motor entrains in rotation the inner gear 22 under a rotation speed ω₂ (in clockwise direction) which is connected to the stirring means 9 to move them under rotation speed ω₂ around the container axis 92. The output gear 23 is then entrained in rotation, under speed ω₁ (in counter clockwise direction) by gearing the teeth in the fixed external gear 21, which provides the gyration speed ω₁ to the stirring means 9 around the stirring means axis 91. When the output gear 23 comprises for example 25 teeth, the ratio between ω₁ and ω₂ is given by the formula below, such that ω₁ is three times ω₂, so the gyration of the stirring means 9 around the stirring means axis 91 is three times the rotation ω₂ of the stirring means around the container axis 92. Additionally, the negative sign indicates the change of direction, from clockwise direction of ω₂ to the counter clockwise direction of ω₁.

$${ω}_{1} = {ω}_{2} \cdot ( - \frac{100}{25} ) + {ω}_{2} = {ω}_{2} \cdot ( - \frac{100}{25} + 1 ) = - 3 \cdot {ω}_{2}$$

Because the preparation machine 100 of the invention is used for a large variety of chilled or frozen products such as ice-cream, milkshakes, sorbets, frozen yoghurt, whipped yoghurt, smoothies, cold beverages or the like, more than one ratio (ω₁/ω₂) needs to be provided by the stirring device 5 of the invention, as a function of the targeted product. Moreover, according to the invention, this ratio needs to be automatically provided by the preparation machine 100 (by the control device 6 in the machine 100) as a function of the product in the container 10. In order to achieve this, the invention provides a stirring device 5 configured as will be described in further detail in what follows.

The stirring device 5 of the invention comprises a stirring mechanism 90 which entrains in rotation the stirring means 9 (particularly, is able to provide the stirring means 9 with the first rotation ω₁ and with the second rotation ω₂) and connection means 5a that connect the stirring means 9 with the stirring mechanism 90. The quotient of (ω₁/ω₂) defines the ratio of the epicyclic movement of the stirring means 9. The stirring mechanism 90 of the invention comprises one motor (not shown in the Figures attached) and is able to provide with a simple configuration different ratios (ω₁/ω₂) of the stirring means 9.

Preferably, the stirring mechanism 90 can provide two different ratios (ω₁/ω₂) as a function of the rotational direction of the said stirring mechanism 90, clockwise or counter clockwise direction. The switch between the two rotational directions and, thus, between the two ratios, is done fully automatically and only one motor being required. By providing different ratios, different stirring parameters are provided and therefore different product configurations being possible, while using only one motor, which maintains the machine with a simple configuration.

The epicyclical stirring mechanism 90 of the invention, providing a direction dependent ratio, comprises as shown in FIGS. 4a-b-c the following components:
a fixed internal gear 93 that is fixedly attached to the machine 100;
an input shaft 94 that is actively driven in rotation by the motor around the container axis 92 (the stirring mechanism 90 is therefore aligned with the container axis 92,); primary transmission gear 95 and secondary transmission gear 96 are arranged on the input shaft 94, each preferably comprising more than one gear and being arranged at two different heights in the input shaft 94;
an output shaft holder 97 entrained in rotation by the input shaft 94, also rotating around the same container axis 92;
an output shaft 98 solidary to the output shaft holder 97 driving the stirring means 9 under rotations ω₁ and ω₂ for preparing the chilled or frozen product targeted.

When described that the input shaft 94 is actively driven in rotation by the motor around the container axis 92 several possibilities should effectively be understood and therefore comprised within the scope of the present invention: either the motor directly acts on the input shaft 94, i.e. directly drives it, or it acts on the input shaft 94 not directly, but through a transmission path such as gears or the like.

Preferably, the output shaft 98 comprises two gears, an upper output gear 981 and a lower output gear 982, as shown in FIGS. 4b and 4c. These two gears are preferably arranged at two different heights with respect to either the input shaft 94 or the output shaft holder 97; in fact they are arranged at different heights corresponding to those of the primary and secondary transmission gear 95, 96 respectively. Preferably, the primary transmission gear 95 is arranged at the same height as the upper output gear 981 so that they mechanically engage and the primary transmission gear entrains in rotation the upper output gear 981.

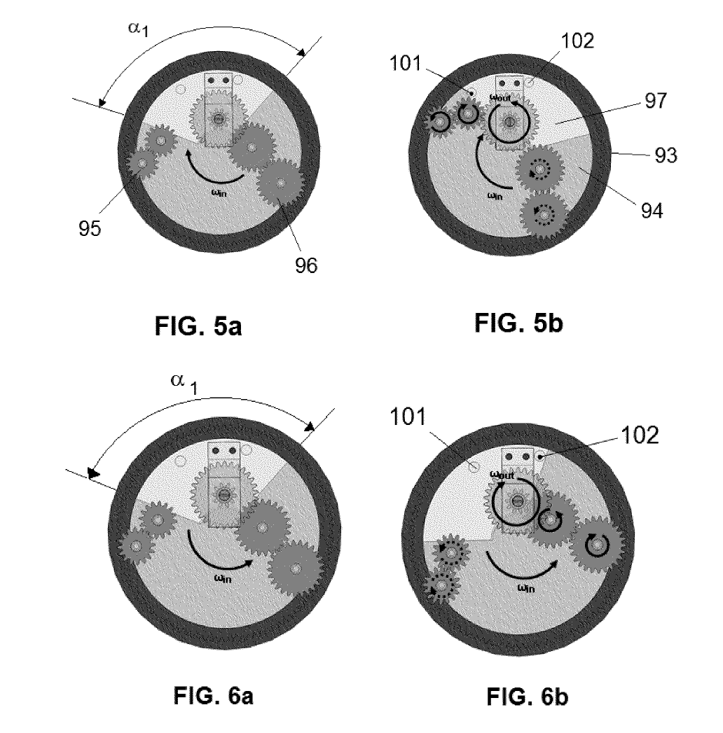

When the input shaft 94 is rotating in clockwise direction, the functioning of the different elements in the stirring mechanism 90 is schematically represented in FIGS. 5a and 5b.

When a torque is applied on the input shaft 94 by the motor, the input shaft 94 starts rotating with a rotational speed ωᵢₙ while the output shaft holder 97 remains static, as the input shaft 94 and the output shaft holder 97 are arranged being disengaged under a certain relative angle α₁ between them, as shown in FIGS. 5a-b. Once the input shaft 94 contacts a first contacting element 101 it engages and enters into mechanical contact with the output shaft holder 97, so the primary transmission gear 95 moving inside the teeth of the fixed internal gear 93 now engages the output shaft 98 and thus entrains it under a rotational speed ωₒᵤₜ. Specifically, the primary transmission gear 95 engages the upper output gear 981.

Using an even number of gears (two, in the preferred embodiments shown) in the primary transmission gear 95 has the consequence that the upper output gear 981 rotates in the opposite direction compared to the input shaft 94. Furthermore, the ratio between the two is (−Nᵢₙ/Nₒᵤₜ₁), Nᵢₙ being the number of internal teeth of the fixed internal gear 93, and Nₒᵤₜ₁ is the number of teeth of the upper output gear 981.

When the input shaft 94 is rotating in counter clockwise direction, the functioning of the different elements in the stirring mechanism 90 is schematically represented in FIGS. 6a and 6b.

When a torque is applied on the input shaft 94 by the motor, the input shaft 94 starts rotating with a rotational speed ωᵢₙ while the output shaft holder 97 remains static, as the input shaft 94 and the output shaft holder 97 are arranged being disengaged under a certain relative angle α₁ between them, as shown in FIGS. 6a-b. Once the input shaft 94 contacts a second contacting element 102 it engages and enters into mechanical contact with the output shaft holder 97, so the secondary transmission gear 96 moving inside the teeth of the fixed internal gear 93 now engages the output shaft 98 and thus entrains it under a rotational speed ωₒᵤₜ. Specifically, the secondary transmission gear 96 engages the lower output gear 982.

Using an even number of gears (two, in the preferred embodiments shown) in the secondary transmission gear 96 has the consequence that the lower output gear 982 rotates in the opposite direction compared to the input shaft 94. Furthermore, the ratio between the two is (−Nᵢₙ/Nₒᵤₜ₂), Nᵢₙ being the number of internal teeth of the fixed internal gear 93, and Nₒᵤₜ₂ is the number of teeth of the lower output gear 982.

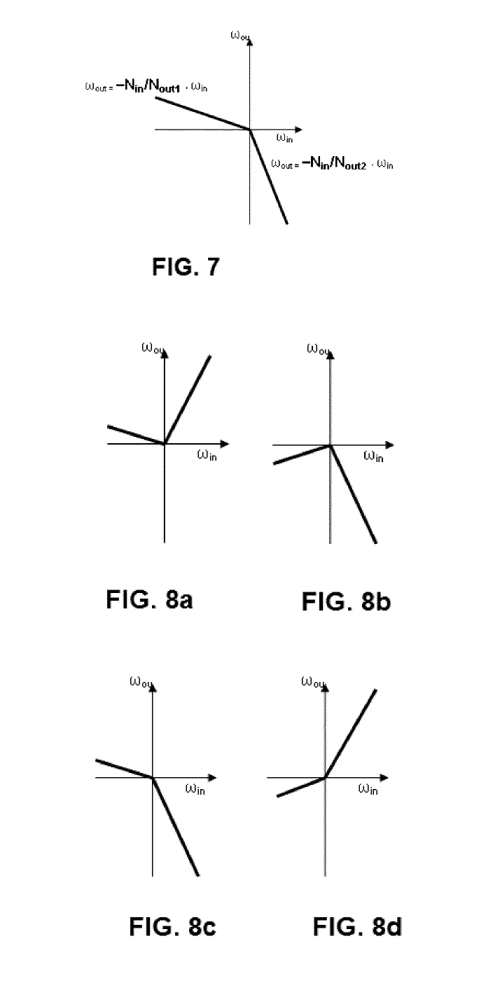

FIG. 7 represents the relation between the rotational speed ωᵢₙ of the input shaft 94 provided by the motor in the stirring mechanism 90 (i.e. the input rotation provided to the stirring mechanism 90) and the rotational speed ωₒᵤₜ of the output shaft 98 (i.e. the output rotation obtained from the stirring mechanism 90). The graph in FIG. 7 further represents that the ration between these two rotational speeds changes depending on the direction of rotation of the input shaft 94. FIG. 7 shows the principle of the present invention, the ratio (ωₒᵤₜ/ωᵢₙ) changing depending on the direction of rotation introduced by the motor as ωᵢₙ.

In the present invention, the stirring means 9 rotate around the container axis 92 under a rotational speed ωᵢₙ provided by the motor to the input shaft 94, typically known as gyration. Furthermore, the stirring means 9 also rotate in spin around its axis (stirring means axis 91) under a rotational speed ωₒᵤₜ.

The references used for the rotational directions are the standard ones, i.e., positive for counter clockwise rotational direction and negative for clockwise rotational direction.

When using an even number of gears in the primary transmission gear 95 and/or in the secondary transmission gear 96 (depending on the direction of rotation of ωᵢₙ) the ratio obtained is negative, meaning that the output rotation ωₒᵤₜ of the output shaft 98 occurs in the opposite direction to the input rotation ωᵢₙ introduced by the motor to the input shaft 94. This is represented in FIG. 7 attached, as previously explained.

However, an uneven or odd number of gears for the primary transmission gear 95 and/or for the secondary transmission gear 96 can be used as well, so as to obtain a positive ratio (ωₒᵤₜ/ωᵢₙ), meaning that the output rotation ωₒᵤₜ of the output shaft 98 occurs in the same direction to the input rotation ωᵢₙ introduced by the motor to the input shaft 94. This is shown for example in FIG. 8d.

However, what has been said before represents an embodiment as shown for example in FIGS. 3a-b or 4a-b-c, where a fixed internal gear 93 is provided as it will be further explained in more detail. Nonetheless, according to a different embodiment (not shown in the Figures), the stirring mechanism can comprise a fixed external gear instead (instead of being arranged in the internal face, it will be arranged in the external face of the stirring mechanism 90): in this case, the ratio being positive or negative will then also depend not only on the even or odd number of gears in the primary transmission gear 95 and/or in the secondary transmission gear 96 but also on the positioning of this gear, internally or externally. All possible combinations will then be anyway comprised within the scope of the present invention. When talking in what follows of internal gear 93, it should also be understood that the gear can be arranged externally instead: we talk of positioning of the internal gear 93, to mean in fact both possible arrangements.

Moreover, by using an even or an odd number of gears in one of the primary transmission gear 95 and/or on the secondary transmission gear 96, all sorts of combinations are possible, so the ratio obtained can be positive or negative, designed independently from the input rotational direction ωᵢₙ introduced by the motor to the input shaft 94, as represented for example in FIGS. 8a-b-c.

Taking for example the graph represented in FIG. 8a, the secondary transmission gear 96 will have an odd number of gears and the primary transmission gear 95 will have an even number of gears. In this case, when the input rotation ωᵢₙ in the input shaft 94 is positive (counter clockwise direction) the output rotation ωₒᵤₜ of the output shaft 98 will also be positive, i.e. counter clockwise. When the direction of rotation introduced by the motor ωᵢₙ in the input shaft 94 is negative (clockwise direction), because the number of gears in the primary transmission gear 95 is even, the output rotation ωₒᵤₜ of the output shaft 98 will still be positive, i.e. counter clockwise. So, in this case, even if the direction of rotation ωᵢₙ changes, the output rotation ωₒᵤₜ will remain always positive, i.e. in counter clockwise direction.

Different combinations are also possible as shown in FIG. 8b, with similar reasoning as the one followed for FIG. 8a.

FIGS. 8c-d show alternatives similar to the one shown in FIG. 7, where the output rotation ωₒᵤₜ of the output shaft 98 is made dependent on the direction of rotation of the input shaft ωᵢₙ.

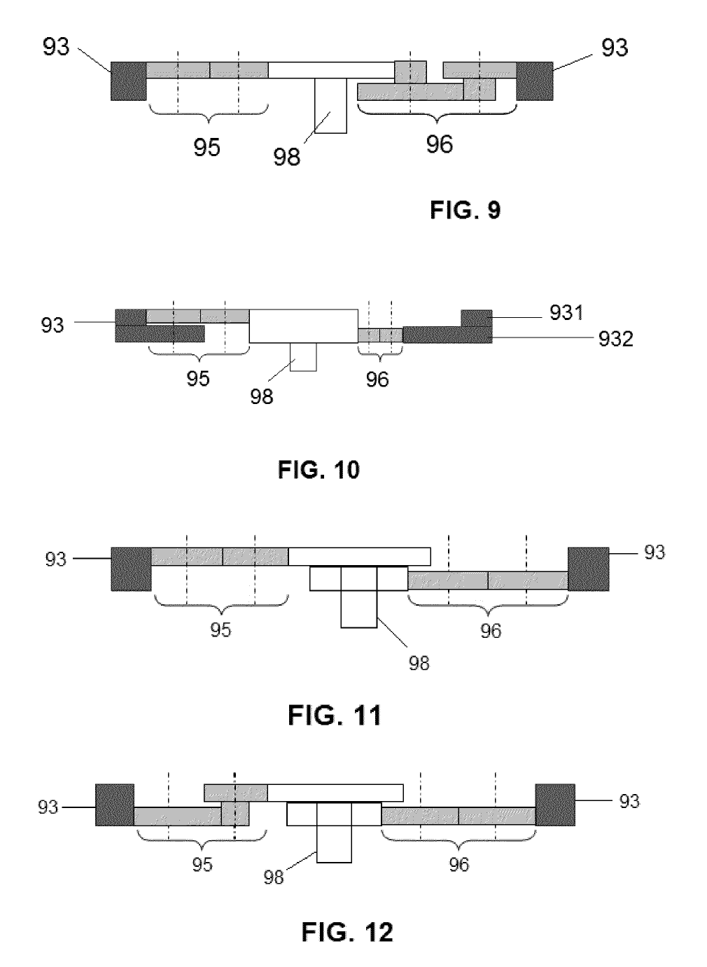

In the examples presented above as preferred embodiments of the invention, the different ratios (ωₒᵤₜ/ωᵢₙ) in value are obtained by modifying the number of teeth in the upper output gear 981 (Nₒᵤₜ₁) and in the lower output gear 982 (Nₒᵤₜ₂), these upper and lower output gears configuring two different stages in the output shaft 98. However, there other embodiments of the output shaft 98 are also possible, in order to simplify it and use only one stage in it, while still obtaining different ratios, this being achieved by making the difference of ratio at other locations:
in the primary and/or secondary transmission gears 95, 96 using a known transmission gearbox: FIG. 9 shows a possible embodiment, where the secondary transmission gear 96 comprises a gearbox;
in the fixed internal gear 93, by using for example two different inner gear diameters, as shown in FIG. 10, where the fixed internal gear 93 comprises an upper inner gear diameter 931 and a lower inner gear diameter 932.

The main principle of the invention is to provide a stirring mechanism 90 that comprises a plurality of transmission paths, these transmission paths being selected as a function of the direction of rotation of the input shaft 94. By transmission path, according to the present invention, it should be understood the transmission or movement path followed by the gears that are engaged or meshed which starts or departs from the input shaft 94 and ends output shaft 98, i.e. from ωᵢₙ provided by the motor to ωₒᵤₜ provided in the output shaft 98. The aim of the invention is therefore to provide diverse transmission paths which give a certain ratio (ωₒᵤₜ/ωᵢₙ) that is chosen as a function of the chilled or frozen product prepared by the machine of the invention, this ratio (ωₒᵤₜ/ωᵢₙ) being further determined by the direction of rotation of the input shaft 94.

In a preferred embodiment of the invention, different transmission paths can be selected as different transmission gears are arranged at different heights in the input shaft 94, further ratio selections being possible also depending on the direction of rotation of the input shaft 94.

The Figures attached and the references used indicate straight gears; however, any other kind of gears can be used and will also fall within the scope of the present invention, such as helical, double helical, spiral, hypoid, conical, or the like.

As explained previously, some of the main advantages of the preparation machine of the invention are:
still using a simple mechanism, the possibility of changing ratio is provided;
the machine also provides the possibility of adapting the rotational output direction by using an even or odd number of transmission gears.

Although the present invention has been described with reference to preferred embodiments thereof, many modifications and alternations may be made by a person having ordinary skill in the art without departing from the scope of this invention which is defined by the appended claims.

### REFERENCES

100 Machine

1 Container receiving means

4 Cooling unit

1a Cooling element

2 Liquid tank

2a Dispensing means

3 Topping tank

5 Stirring device

90 Stirring mechanism

5a Connection means

6 Control unit

7 Mobile structure

9 Stirring means

ω₁ Rotation of stirring means around own axis

ω₂ Rotation of stirring means around container axis

91 Stirring means axis

92 Container axis

21 Fixed external gear (P. Art)

22 Inner gear (P. Art)

23 Output gear (P. Art)

93 Fixed internal gear

931 Upper inner gear diameter

932 Lower inner gear diameter

94 Input shaft

95 Primary transmission gear

96 Secondary transmission gear

97 Output shaft holder

98 Output shaft

981 Upper output gear

982 Lower output gear

α₁ Disengaging angle between output shaft holder and input shaft

101 First contacting element

102 Second contacting element

ωᵢₙ Rotation of input shaft

ωₒᵤₜ Rotation of output shaft

Nᵢₙ Number of teeth of fixed internal gear

Nₒᵤₜ₁ Number of teeth of upper output gear

Nₒᵤₜ₂ Number of teeth of lower output gear

10 Preparation container

1. Stirring mechanism for a machine for preparing chilled or frozen products comprising one motor, the stirring mechanism comprising at least one transmission path between an input shaft rotatable at a speed (ωᵢₙ) by the motor and an output shaft rotatable at a speed (ωₒᵤₜ), the transmission path providing different values of the ratio (ωᵢₙ/ωₒᵤₜ) and being selectable as a function of the direction of rotation of the input shaft.

2. Stirring mechanism according to claim 1, wherein the transmission path comprises transmission gears arranged at different heights in the stirring mechanism.

3. Stirring mechanism according to claim 1, wherein the output shaft comprises one or a plurality of gear stages engaging with transmission gears as a function of the direction of rotation of the input shaft such that different ratios (ωᵢₙ/ωₒᵤₜ) can be provided depending on the product.

4. Stirring mechanism according to claim 3, wherein the transmission gears are arranged in the input shaft.

5. Stirring mechanism according to claim 3, wherein the output shaft comprises two gear stages engaging with transmission gears depending on the direction of rotation of the input shaft, so two different ratios (ωᵢₙ/ωₒᵤₜ) are provided as a function of the product.

6. Stirring mechanism according to claim 1, wherein the number of gears in the transmission gears is selected so as to provide different combinations of positive and/or negative ratios (ωᵢₙ/ωₒᵤₜ) as a function of the direction of rotation of the input shaft.

7. Stirring mechanism according to claim 3 wherein at least one of the transmission gears comprises a gear box.

8. Stirring mechanism according to claim 1, comprising an inner gear driving the rotation of the transmission gears around the stirring mechanism axis.

9. Stirring mechanism according to claim 8, wherein the ratio (ωᵢₙ/ωₒᵤₜ) depends on the number of teeth in the inner gear and/or in the transmission gears.

10. Stirring mechanism according to claim 8, wherein the inner gear comprises different internal diameters engaging with transmission gears depending on the direction of rotation of the input shaft so that different ratios (ωᵢₙ/ωₒᵤₜ) are provided.

11. Stirring mechanism according to claim 8, wherein the ratio (ωᵢₙ/ωₒᵤₜ) is negative or positive as a function of the number of gears in the transmission gear engaging with the output shaft and as a function of the positioning of the inner gear.

12. Stirring mechanism according to claim 1, configured such that it comprises a disengagement angle where the input shaft rotates while the output shaft remains static.

13. Stirring mechanism according to claim 12, comprising first and second contacting elements collaborating with the input shaft in order to define the disengagement angle.

14. Machine for preparing chilled or frozen products comprising a stirring mechanism comprising one motor, the stirring mechanism comprising at least one transmission path between an input shaft rotatable at a speed (ωᵢₙ) by the motor and an output shaft rotatable at a speed (ωₒᵤₜ), the transmission path providing different values of the ratio (ωᵢₙ/ωₒᵤₜ) and being selectable as a function of the direction of rotation of the input shaft, the stirring mechanism entraining in rotation a stirring member to prepare the product.

15. System comprising a machine according to claim 14 and a container comprising the ingredient or ingredients for preparing the product by the rotation of the stirring member.
